(19) United States
(12) Patent Application Publication
(10) Pub. No.: US 2024/0014581 A1
(43) Pub. Date: Jan. 11, 2024

(54) TERMINAL BLOCK

(71) Applicant: SUMITOMO WIRING SYSTEMS, LTD., Yokkaichi-shi, Mie-ken (JP)

(72) Inventor: Eisaku IWAKURA, Yokkaichi-shi (JP)

(21) Appl. No.: 18/250,540

(22) PCT Filed: Nov. 11, 2021
(86) PCT No.: PCT/JP2021/041512

§ 371 Date: Apr. 26, 2023

(30) Foreign Application Priority Data
Nov. 12, 2020 (JP) 2020-188953

(51) Int. Cl. H01R 9/24; H01R 13/52; H01R 9/18

(52) U.S. Cl. CPC H01R 9/24; H01R 13/5227; H01R 9/18

(57) ABSTRACT

A terminal block is used in an attitude such that a first end portion of a block main body is positioned lower than the opposite second end portion of the block main body. A through hole is provided in the second end portion of the block main body. The block main body includes a rib that extends in the first direction and that, when viewed in the first direction, has a shape that covers a first end portion side of the through hole. A straight line that is orthogonal to a center axis of the through hole and that extends along the second direction is set as a reference line; and a side surface on the through hole side of the rib includes a spaced-apart surface that is spaced farther apart from the through hole the greater the distance from the reference line.

### BACKGROUND

### Field of the Disclosure

The present disclosure relates to a terminal block.

### Related Art

Japanese Laid-Open Patent Publication No. 2011-160619 (JP'619) discloses an example of a terminal block for a vehicle. The terminal block includes a block main body and terminals held by the block main body. The block main body includes through holes for accommodating fastened bolts. The block main body includes a first end and a second end. The first end is one end of the block main body in a direction orthogonal to an extension direction of the through holes. The second end is the other end of the block main body located opposite to the first end. The through holes include a first through hole arranged in the first end and a second through hole arranged in the second end. Further, the block main body includes a first reinforcement rib arranged around the first through hole and a second reinforcement rib arranged around the second through hole. The first rib extends in the extension direction of the first through hole. As viewed in the extension direction of the first through hole, the first rib is shaped such that the first rib extends around the side of the first through hole located toward the second end. The second rib extends in the extension direction of the second through hole. As viewed in the extension direction of the second through hole, the second rib is shaped such that the second rib extends around the side of the second through hole located toward the first end. The block main body is fastened to an associated device by bolts inserted into the first through hole and the second through hole. The first rib opposes the head of the bolt inserted through the first through hole. The second rib opposes the head of the bolt inserted through the second through hole.

### SUMMARY

Such a terminal block may be used in a state positioned such that the block main body is tilted, and the first end is lower than the second end. In this case, water collected around the second through hole flows toward the first end due to the tilt of the block main body. However, the water may be dammed by the second rib, which is arranged at the side of the second through hole located toward the first end. This may cause corrosion of the fastened bolt in the second through hole unless a corrosion countermeasure is taken.

Accordingly, an objective is to provide a terminal block that avoids corrosion of a fastened bolt accommodated in a through hole.

A terminal block in accordance with the present disclosure includes a block main body and terminals held by the block main body. The block main body includes a through hole, a first end, and a second end. The through hole is for accommodating a fastened bolt. The first end is one end of the block main body in a second direction that is orthogonal to a first direction in which the through hole extends through the block main body. The second end is an end of the block main body located opposite to the first end in the second direction. The terminal block is used in a state in which the block main body is tilted and the first end is lower than the second end. The through hole includes a first through hole and a second through hole. The first through hole extends through the first end in the first direction. The second through hole extends through the second end in the first direction. The block main body includes a first rib and a second rib. The first rib extends in the first direction and is shaped such that the first rib extends around a side of the first through hole that is located toward the second end as viewed in the first direction. The second rib extends in the first direction and is shaped such that the second rib extends around a side of the second through hole that is located toward the first end as viewed in the first direction. A straight line orthogonal to a center axis of the second through hole and parallel to the second direction is referred to as a reference line. The second rib includes a side surface located toward the second through hole. The side surface includes a receding surface that extends away from the second through hole as the receding surface becomes farther away from the reference line.

The present disclosure provides a terminal block that avoids corrosion of a fastened bolt accommodated in a through hole.

### BRIEF DESCRIPTION OF DRAWINGS

FIG. 1 is a perspective view of a terminal block in accordance with an embodiment.

FIG. 2 is a side view of the terminal block in accordance with the same embodiment in a state mounted on a vehicle.

FIG. 3 is a plan view of the terminal block in accordance with the same embodiment.

FIG. 4 is an enlarged plan view showing a first end of the terminal block in accordance with the same embodiment.

FIG. 5 is an enlarged plan view showing a second end of the terminal block in accordance with the same embodiment.

FIG. 6 is a cross-sectional view taken along line 6-6 shown in FIG. 4.

FIG. 7 is a cross-sectional view taken along line 7-7 shown in FIG. 4.

### DETAILED DESCRIPTION

### Description of Embodiment of Present Disclosure

An embodiment of the present disclosure will now be described.

(1) A terminal block in accordance with the present disclosure includes terminals held by a block main body. The block main body includes a through hole, a first end, and a second end. The through hole is for accommodating a fastened bolt. The first end is one end of the block main body in a second direction that is orthogonal to a first direction in which the through hole extends through the block main body. The second end is an end of the block main body located opposite to the first end in the second direction. The terminal block is used in a state in which the block main body is tilted and the first end is lower than the second end. The through hole includes a first through hole and a second through hole. The first through hole extends through the first end in the first direction. The second through hole extends through the second end in the first direction. The block main body includes a first rib and a second rib. The first rib extends in the first direction and is shaped such that the first rib extends around a side of the first through hole that is located toward the second end as viewed in the first direction. The second rib extends in the first direction and is shaped such that the second rib extends around a side of the second through hole that is located toward the first end as viewed in the first direction. A straight line orthogonal to a center axis of the second through hole and parallel to the second direction is referred to as a reference line. The second rib includes a side surface located toward the second through hole. The side surface includes a receding surface that extends away from the second through hole as the receding surface becomes farther away from the reference line.

With this structure, the distance from the fastened bolt in the second through hole to the receding surface of the second rib becomes greater as the receding surface becomes farther away from the reference line. Thus, the receding surface assists drainage of the water entering the gap between the bolt and the second rib. This avoids corrosion of the fastened bolt in the second through hole, which is located at the upstream side of the block main body with respect to the inclination.

(2) The first rib includes a side surface located toward the first through hole. The side surface is entirely arc-shaped and centered about a center axis of the first through hole.

With this structure, water is unlikely to collect on the first end 14, which is located at the downstream side of the block main body 11 with respect to the inclination. Thus, the first rib is not provided with a receding surface as in the second rib, and the side surface of the first rib is entirely arc-shaped and centered about the center axis of the first through hole. This improves the strength around the first through hole.

(3) In the block base body, a side of the first through hole located toward the first rib in the second direction is referred to as an inner side, and a side of the first through hole opposite to the inner side in the second direction is referred to as an outer side. The outer side of the first through hole in the second direction is free from a rib that opposes the first rib in the second direction.

With this structure, the outer side of the first through hole in the second direction is free from a rib that opposes the first rib in the second direction. Thus, the water collected around the first through hole is easily drained out of the first end in the second direction. This avoids corrosion of the fastened bolt in the first through hole.

(4) The terminals are arranged next to each other in the second direction.

This structure allows the terminal block of the terminals to be reduced in length in the third direction that is orthogonal to both of the first and second directions.

(5) The first end includes a bottom wall having an upper surface. The bottom wall includes a drain portion shaped such that the upper surface becomes closer to a lower surface from a side of the second end toward a side of the first end.

With this structure, the drain portion allows the water collected on the upper surface of the first end to be drained toward the edge of the first end in the second direction.

(6) The upper surface of the drain portion is stepped such that the upper surface becomes closer to the lower surface from the side of the second end toward the side of the first end.

This structure allows the block main body to be easily removed from a mold, thereby improving moldability of the block main body.

(7) The lower surface of the bottom wall includes a recess that receives a sealing member. The recess is arranged in the lower surface of the bottom wall so as not to extend across steps of the drain portion.

With this structure, the lower surface of the bottom wall, including the recess, can be shaped in correspondence with the steps of the upper surface of the drain portion. Accordingly, the bottom wall has minimal changes in the thickness. This avoids deformation, such as shrinkage, that would be caused by unevenness in the thickness of the bottom wall.

(8) The first through hole includes two first through holes arranged next to each other in a direction that is orthogonal to the first direction and intersects the second direction. The block main body includes a third rib arranged between the two first through holes and extending in the first direction. The third rib extends in the second direction as viewed in the first direction.

This structure further improves the strength of the first end. Also, the third rib functions as a guide for draining the water collected on the upper surface of the first end toward the edge of the first end in the second direction.

### Detailed Description of Embodiment of Present Disclosure

A specific example of the terminal block in accordance with the present disclosure will now be described with reference to the drawings. To facilitate understanding, configurations may be partially exaggerated or simplified in the drawings. Further, elements in the drawings may not be to scale. In the present specification, “orthogonal” and “perpendicular” include not only strictly orthogonal cases and strictly perpendicular cases but also include generally orthogonal cases and generally perpendicular cases within a range allowing the advantages of the present embodiment to be obtained.

The drawings show three directions orthogonal to one another, namely, a first direction D1, a second direction D2, and a third direction D3. Specifically, the first direction D1 is orthogonal to the second direction D2, the first direction D1 is orthogonal to the third direction D3, and the second direction D2 is orthogonal to the third direction D3.

In the present specification, “the form of a plate” includes a plate-shape of which corners and edges are chamfered or rounded. Also, a recess, a projection, and the like may be formed on part of or all of the plate-shape. The term “cylindrical” as used in this description is not limited to a structure formed by a circumferential wall that extends continuously to be closed in the circumferential direction and also includes cylindrical structures formed by combining multiple parts or a structure that is C-shaped and open in the circumferential direction. Cylindrical shapes include circular, elliptic, and polygonal shapes.

In the present specification, “loop” refers to an entirely seamless structure like a ring, that is, an endless structure having an initiating point and a terminating point that coincide with each other. Further, “loop” in this specification includes endless shapes of which the outer edge has the form of a circle, ellipse, oval, polygon, or polygon with rounded corners, as well as any closed shape having the outer edge formed by a straight line or a curved line. The term “loop” includes a shape that includes an outer edge and an inner edge shaped identically or differently. The term “loop” includes a shape that has a predetermined length along its central axis, and the length may be large or small. Furthermore, “closed shape” in the present specification may only be regarded as a loop as a whole and includes shapes having a gap, a slit, or the like as in a C-shape.

### Terminal Block 10

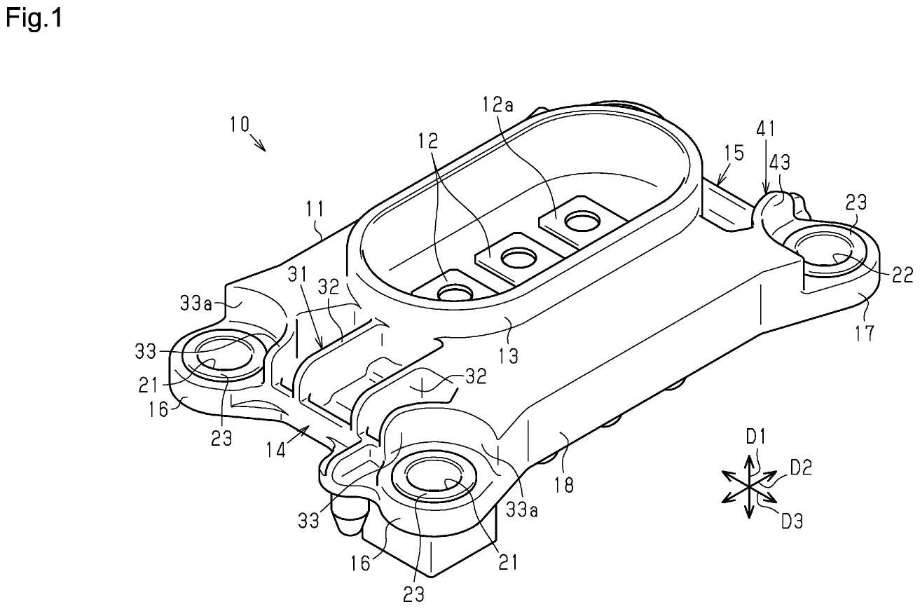

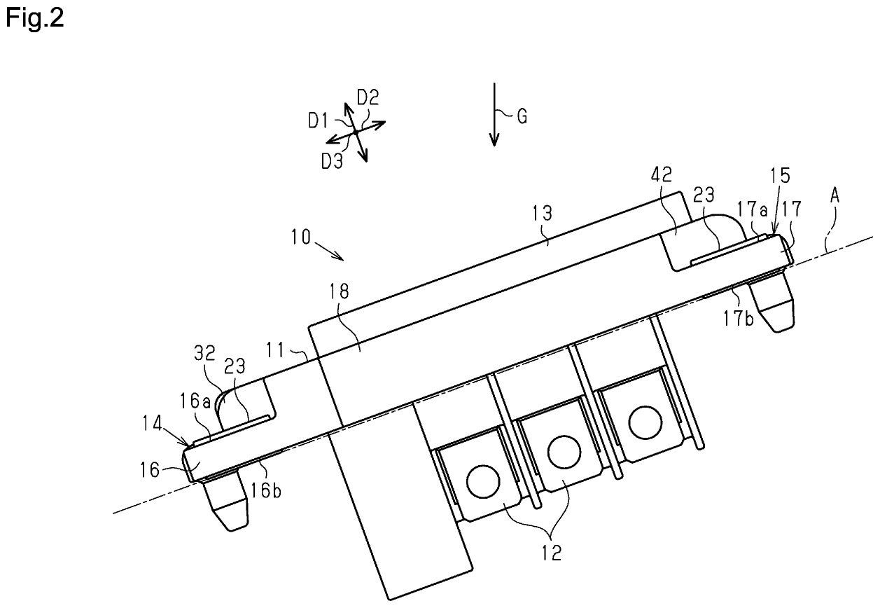

A terminal block 10 of the present embodiment shown in FIGS. 1 and 2 is coupled to a coupling surface A of a device installed in a vehicle. As shown in FIG. 2, the coupling surface A is inclined with respect to the gravitational direction G. Thus, the terminal block 10 is tilted with respect to the gravitational direction Gin a state coupled to the coupling surface A. In the coupled state, the terminal block 10 is tilted by, for example, approximately twenty degrees. The device is, for example, a driving motor for a battery electric vehicle, a hybrid electric vehicle, or the like.

As shown in FIG. 1, the terminal block 10 includes a block main body 11 and terminals 12 held by the block main body 11. The block main body 11 is mainly formed from, for example, synthetic resin. Further, the block main body 11 is formed through, for example, injection molding.

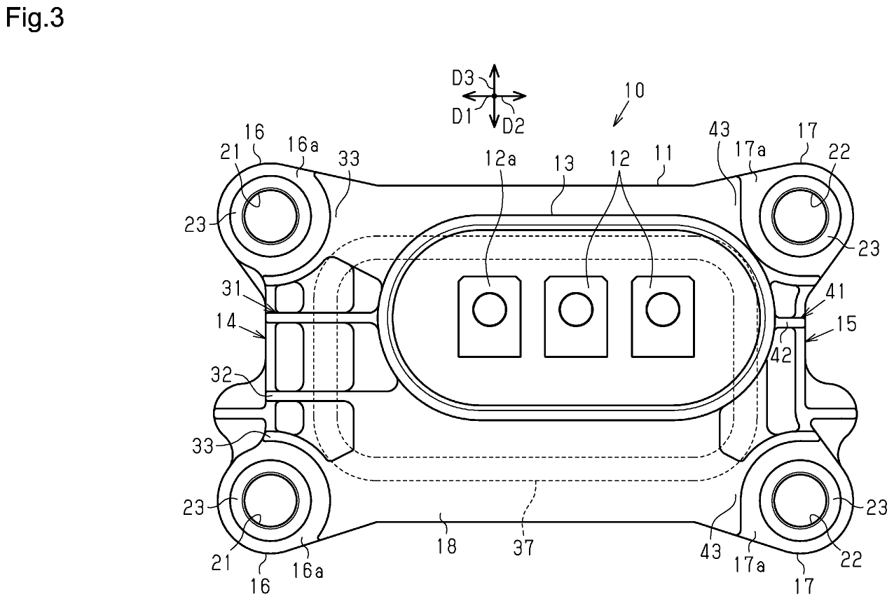

FIG. 3 shows the terminal block 10 as viewed in the first direction D1. As shown in FIG. 3, the block main body 11 is longer in the second direction D2 than the third direction D3 as viewed in the first direction D1. The block main body 11 is, for example, substantially rectangular as viewed in the first direction D1.

The terminal block 10 includes, for example, multiple terminals 12. The terminals 12 are, for example, arranged next to each other in the second direction D2. Each terminal 12 includes one end 12a in the first direction D1 that is connected to a corresponding terminal of an associated connector (not shown). The terminal of the connector is connected to the terminal 12 in the first direction D1. The other end of the terminal 12 in the first direction D1 is connected to a corresponding terminal of the above-mentioned device.

The one ends 12a of the terminals 12 in the first direction D1 are surrounded by a circumferential wall 13 arranged on the block main body 11. The circumferential wall 13 extends in the first direction D1. Further, the circumferential wall 13 has a closed shape as viewed in the first direction D1. The terminals 12 are arranged inside the looped circumferential wall 13. The circumferential wall 13 is fitted to a holder of the terminals of the associated connector.

### Block Main Body 11

As shown in FIGS. 1 and 3, the block main body 11 includes a first end 14 and a second end 15. The first end 14 is one end of the block main body 11 in the second direction D2. The second end 15 is an end of the block main body 11 opposite to the first end 14 in the second direction D2. The circumferential wall 13 is arranged between the first end 14 and the second end 15. As shown in FIG. 2, the block main body 11 is coupled to the coupling surface Ain a tilted state in which the first end 14 is lower than the second end 15.

As shown in FIGS. 2 and 3, the block main body 11 includes first fastening portions 16 fastened to the coupling surface A. Further, the block main body 11 includes second fastening portions 17 fastened to the coupling surface A. The first fastening portions 16 are, for example, respectively arranged on two ends of the first end 14 in the third direction D3. The second fastening portions 17 are, for example, respectively arranged on two ends of the second end 15 in the third direction D3. In other words, in the block main body 11 of the present embodiment, four fastening portions, namely, two first fastening portions 16 and two second fastening portions 17, are respectively arranged on four corners of the block main body 11 as viewed in the first direction D1. The first fastening portions 16 and the second fastening portions 17 are each fastened to the coupling surface A by, for example, a bolt or the like. The first fastening portions 16 and the second fastening portions 17 are, for example, formed to be thinner than a main part 18 of the block main body 11 in the first direction D1. The main part 18 of the block main body 11 is a portion of the block main body 11 between the first end 14 and the second end 15. The circumferential wall 13 is arranged on the main part 18.

The block main body 11 includes first through holes 21 and second through holes 22 for accommodating fastened bolts. The block main body 11 includes, for example, two first through holes 21. The first through holes 21 are arranged in the two first fastening portions 16, respectively. Further, the block main body 11 includes, for example, two second through holes 22. The second through holes 22 are arranged in the two second fastening portions 17, respectively. A fastening bolt (not shown) is inserted through each of the first and second through holes 21 and 22.

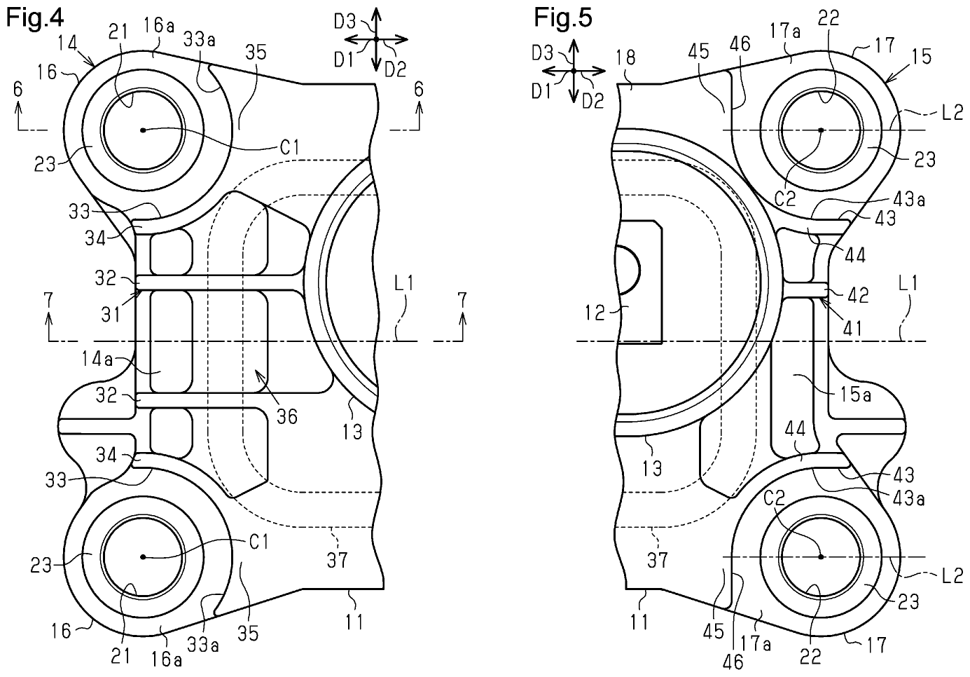

As shown in FIG. 4, the first through holes 21 extend through corresponding first fastening portions 16 in the first direction D1. Each first through hole 21 is, for example, circular as viewed in the first direction D1. One of the first through holes 21 is arranged in one end of the first end 14 in the third direction D3. The other one of the first through holes 21 is arranged in the other end of the first end 14 in the third direction D3. In other words, one of the first through holes 21 is arranged at one side of the block main body 11 in the third direction D3 with respect to a centerline L1, and the other one of the first through holes 21 is arranged at the other side of the block main body 11 with respect to the centerline L1.

In the description hereafter, the side of the first through hole 21 located toward the centerline L1 in the third direction D3 will be referred to as “the inner side of the first through hole 21 in the third direction D3”, and the side opposite to the inner side will be referred to as “the outer side of the first through hole 21 in the third direction D3”. Further, in the description hereafter, the side of the first through hole 21 located toward the second end 15 in the second direction D2 will be referred to as “the inner side of the first through hole 21 in the second direction D2”, and the side opposite to the inner side will be referred to as “the outer side of the first through hole 21 in the second direction D2”.

The two first through holes 21 are arranged next to each other in the third direction D3. Specifically, the two first through holes 21 are arranged next to each other in a direction that is orthogonal to the first direction D1 and intersects the second direction D2.

As shown in FIG. 5, the second through holes 22 extend through corresponding second fastening portions 17 in the first direction D1. Each second through hole 22 is, for example, circular as viewed in the first direction D1. One of the second through holes 22 is arranged in one end of the second end 15 in the third direction D3. The other one of the second through holes 22 is arranged in the other end of the second end 15 in the third direction D3. In other words, one of the second through holes 22 is arranged at one side of the block main body 11 in the third direction D3 with respect to the centerline L1, and the other one of the second through holes 22 is arranged at the other side of the block main body 11 with respect to the centerline L1.

In the description hereafter, the side of the second through hole 22 located toward the centerline L1 in the third direction D3 will be referred to as “the inner side of the second through hole 22 in the third direction D3”, and the side opposite to the inner side will be referred to as “the outer side of the second through hole 22 in the third direction D3”. Further, in the description hereafter, the side of the second through hole 22 located toward the first end 14 in the second direction D2 will be referred to as “the inner side of the second through hole 22 in the second direction D2”, and the side opposite to the inner side will be referred to as “the outer side of the second through hole 22 in the second direction D2”.

The second through holes 22 are arranged next to each other in the third direction D3. Specifically, the two second through holes 22 are arranged next to each other in a direction that is orthogonal to the first direction D1 and intersects the second direction D2.

The first and second through holes 21 and 22 are each defined by, for example, a cylindrical collar 23. In other words, each of the first and second through holes 21 and 22 is the hollow portion of a corresponding cylindrical collar 23. The collar 23 is formed from a material, such as metal, having a higher rigidity than the synthetic resin forming the main portion of the block main body 11. Each collar 23 is, for example, partially embedded in the resin part of the corresponding one of the first and second fastening portions 16 and 17.

### First Rib Group 31

As shown in FIG. 4, a first rib group 31 is arranged on the first end 14 of the block main body 11 and extends in the first direction D1. The first rib group 31 includes ribs 32 and ribs 33.

The ribs 32 extend from an upper surface of a bottom wall 14a of the first end 14 in the first direction D1. The bottom wall 14a is a part of the first end 14 that connects the two first fastening portions 16. The side of the bottom wall 14a at which the ribs 32 are arranged will be referred to as the upper side, and the side opposite to the upper side will be referred to as the lower side.

Each rib 32 extends in the second direction D2 as viewed in the first direction D1. The rib 32 has, for example, the form of a plate perpendicular to the third direction D3. For example, there are two ribs 32. The two ribs 32 are arranged next to each other in the third direction D3. The ribs 32 are disposed between the two first through holes 21 in the third direction D3. One of the two ribs 32 is positioned to correspond with, for example, the center position of the circumferential wall 13 in the third direction D3, and one end of this rib 32 in the second direction D2 is connected to an outer surface of the circumferential wall 13.

The first end 14 includes, for example, two ribs 33. Each rib 33 extends around a corresponding first through hole 21.

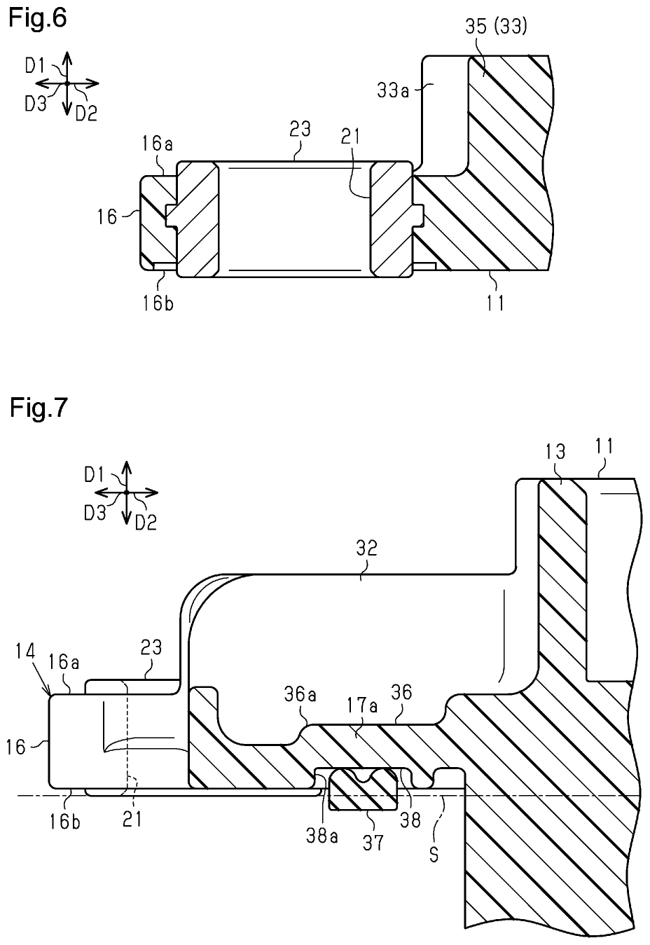

As shown in FIGS. 2 and 6, the resin part of each first fastening portion 16 includes an upper surface 16a and a lower surface 16b. The upper surface 16a is, for example, a flat surface and perpendicular to the first direction D1. The upper end, which is an axial end, of the collar 23 projects out of the upper surface 16a in the first direction D1. The lower surface 16b of the first fastening portion 16 faces the coupling surface A. A bolt (not shown) is fastened to the first fastening portion 16 from the side of the upper surface 16a. The ribs 33 extend from the upper surface 16a of the first fastening portion 16 in the first direction D1.

As shown in FIG. 4, each rib 33 is shaped such that the rib 33 partially extends around the corresponding first through hole 21 in a circumferential direction as viewed in the first direction D1. Further, the rib 33 extends along the periphery of the first through hole 21 as viewed in the first direction D1. Specifically, the rib 33 includes a side surface 33a located toward the first through hole 21. The side surface 33a is entirely arc-shaped in the circumferential direction about a center axis C1 of the first through hole 21.

Each rib 33 includes a first portion 34 and a second portion 35. The first portion 34 is located at the inner side of the corresponding first through hole 21 in the third direction D3. That is, the first portions 34 are located between the two first through holes 21. The two ribs 32 are located between the first portions 34 of the two ribs 33 in the third direction D3.

The second portion 35 is located at the inner side of the each first through hole 21 in the second direction D2. The second portion 35 is shaped such that the second portion 35 extends around the inner side of the first through hole 21 in the second direction D2 as viewed in the first direction D1. In both of the first portion 34 and the second portion 35, the side surface 33a of the rib 33 is arc-shaped and centered about the center axis C1.

As shown in FIGS. 4 and 7, at the side of the upper surface 16a of the first fastening portion 16, the outer side of each first through hole 21 in the second D2 is open. In other words, the outer side of the first through hole 21 in the second direction D2 is free from a rib that opposes the second portion 35 of the rib 33 in the second direction D2.

As described above, the first rib group 31 is disposed between the two first through holes 21. In the present embodiment, the total number of ribs in the first rib group 31 arranged on the first end 14 is four; that is, two ribs 32 and two ribs 33.

As shown in FIGS. 4 and 7, the bottom wall 14a includes a drain portion 36 in the first end 14 of the block main body 11. The drain portion 36 is, for example, arranged between the two ribs 32. Further, the drain portion 36 is arranged, for example, between each rib 32 and the first portion 34 of a corresponding rib 33. The drain portion 36 has a structure in which the upper surface of the bottom wall 14a becomes closer to the lower surface in the second direction D2 from the side of the second end 15 toward the side of the first end 14. Hereinafter, the upper surface of the bottom wall 14a in the drain portion 36 will be referred to as the upper surface of the drain portion 36.

As shown in FIG. 7, the upper surface of the drain portion 36 is, for example, stepped such that the upper surface becomes closer to the lower surface from the side of the second end 15 toward the side of the first end 14. A plane orthogonal to the first direction D1 and lying along the lower end of the first through hole 21 is located will be referred to as a reference surface S. The distance from the upper surface of the drain portion 36 to the reference surface S in the first direction D1 becomes smaller for each descending step of the drain portion 36 from the side of the second end 15 toward the side of the first end 14.

The lower surface of the bottom wall 14a includes a recess 38 that receives a sealing member 37. The lower surface of the block main body 11 includes a groove (not shown) that has a closed shape as viewed in the first direction D1, and the recess 38 is part of the looped recess in the circumferential direction. The looped recess receives the ring-shaped sealing member 37 shown in FIG. 3. In a state in which the terminal block 10 is coupled to the coupling surface A, the sealing member 37 is compressed between the lower surface of the block main body 11 and the coupling surface A. In this manner, the sealing member 37 seals the gap between the terminal block 10 and the coupling surface A.

As shown in FIG. 7, the recess 38 has the form of a groove that extends in the third direction D3 in the lower surface of the bottom wall 14a. Further, the recess 38 is arranged at a position corresponding to one of the steps of the drain portion 36. Specifically, the recess 38 is arranged in the lower surface of the bottom wall 14a so as not to extend across steps of the drain portion 36. In the present embodiment, the drain portion 36 includes three steps, namely, an upper step, a middle step, and a lower step. The recess 38 is arranged in correspondence with the middle step of the drain portion 36. Further, an edge 38a of the recess 38 in the second direction D2 substantially coincides with a boundary 36a of the step of the drain portion 36 in the first direction D1.

### Second Rib Group 41

As shown in FIG. 5, a second rib group 41 is arranged on the second end 15 of the block main body 11 and extends in the first direction D1. The second rib group 41 includes a rib 42 and ribs 43.

The rib 42 extends from a bottom wall 15a of the second end 15 in the first direction D1. The bottom wall 15a is a part of the second end 15 that connects the two second fastening portions 17. The side of the bottom wall 15a at which the rib 42 is arranged will be referred to as the upper side, and the side opposite to the upper side will be referred to as the lower side.

The rib 42 extends in the second direction D2 as viewed in the first direction D1. The rib 42 has, for example, the form of a plate perpendicular to the third direction D3. For example, there is one rib 42. The rib 42 is disposed between the two second through holes 22 in the third direction D3. The rib 42 is positioned to correspond with, for example, the center position of the circumferential wall 13 in the third direction D3. Further, one end of the rib 42 in the second direction D2 is connected to the outer surface of the circumferential wall 13.

The second end 15 includes, for example, two ribs 43. Each rib 43 extends around a corresponding second through hole 22.

As shown in FIG. 2, the resin part of each second fastening portion 17 includes an upper surface 17a and a lower surface 17b. The upper surface 17a is, for example, a flat surface and perpendicular to the first direction D1. The upper end, which is an axial end, of the collar 23 projects out of the upper surface 17a in the first direction D1. The lower surface 17b of the second fastening portion 17 faces the coupling surface A. A bolt (not shown) is fastened to the second fastening portion 17 from the side of the upper surface 17a. The ribs 43 extend from the upper surface 17a of the second fastening portion 17 in the first direction D1.

As shown in FIG. 5, each rib 43 is shaped such that the rib 43 extends around part of the corresponding second through hole 22 in a circumferential direction as viewed in the first direction D1. Further, the rib 43 extends along the periphery of the second through hole 22 as viewed in the first direction D1. Specifically, the rib 43 includes a side surface 43a located toward the second through hole 22. The side surface 43a is entirely arc-shaped in the circumferential direction about a center axis C2 of the second through hole 22.

Each rib 43 includes a first portion 44 and a second portion 45. The first portion 44 is located at the inner side of the corresponding second through hole 22 in the third direction D3. That is, the first portions 44 are located between the two second through holes 22. In the first portion 44, the side surface 43a of the rib 43 is arc-shaped and centered about the center axis C2. The rib 42 is located between the first portions 44 of the two ribs 43 in the third direction D3.

The second portion 45 of each rib 43 is located at the inner side of the corresponding second through hole 22 in the second direction D2. The second portion 45 is shaped such that the second portion 45 extends around the inner side of the second through hole 22 in the second direction D2 as viewed in the first direction D1.

The side surface of the second portion 45 located toward each second through hole 22 defines a receding surface 46. The receding surface 46 is, for example, a flat surface and perpendicular to the second direction D2. That is, the receding surface 46 extends in the third direction D3 as viewed in the first direction D1. The second portion 45 and the receding surface 46 extend, for example, to the edge of the corresponding second fastening portion 17 in the third direction D3. A straight line orthogonal to the center axis C2 of the second through hole 22 and parallel to the second direction D2 will be referred to as the reference line L2. At the outer side of each second through hole 22 in the third direction D3, the receding surface 46 extends away from the corresponding second through hole 22 as the receding surface becomes farther away from the reference line L2 in the third direction D3. In other words, the distance from each second through hole 22 to the corresponding second portion 45 becomes greater toward the outer side of the second through hole 22 in the third direction D3.

At the side of the upper surface 17a of the second fastening portion 17, the outer side of each second through hole 22 in the second direction D2 is open. In other words, the outer side of the second through hole 22 in the second direction D2 is free from a rib that opposes the second portion 45 of the rib 43 in the second direction D2.

As described above, the second rib group 41 is disposed between the two second through holes 22. In the present embodiment, the total number of ribs in the second rib group 41 arranged on the second end 15 is three; that is, one rib 42 and two ribs 43. Thus, the block main body 11 includes a greater number of ribs in the first rib group 31 than the second rib group 41.

The present embodiment has the following advantages.

(1) The rib 43 extends in the first direction D1 and is shaped such that the rib 43 extends around the side of the second through hole 22 that is located toward the first end 14 as viewed in the first direction D1. The straight line orthogonal to the center axis C2 of the second through hole 22 and parallel to the second direction D2 is referred to as the reference line L2. The side surface 43a of the rib 43 located toward the second through hole 22 includes the receding surface 46 that extends away from the second through hole 22 as the receding surface 46 becomes farther away from the reference line L2.

With this structure, the distance from the fastened bolt in the second through hole 22 to the receding surface 46 of the rib 43 becomes greater as the receding surface 46 becomes farther away from the reference line L2. Thus, the receding surface 46 assists drainage of the water entering the gap between the bolt and the rib 43. This avoids corrosion of the fastened bolt in the second through hole 22, which is located at the upstream side of the block main body 11 with respect to the inclination.

(2) The side surface 33a of the rib 33 located toward the first through hole 21 is entirely arc-shaped and centered about the center axis C1 of the first through hole 21. With this structure, water is unlikely to collect between the fastened bolt in the first through hole 21 and the rib 33 on the first end 14, which is located at the downstream side of the block main body 11 with respect to the inclination. Thus, the rib 33 is not provided with a receding surface 46 as in the rib 43, and the side surface 33a of the rib 33 is entirely arc-shaped and centered about the center axis C1 of the first through hole 21. This improves the strength around the first through hole 21.

(3) In the block main body 11, the side of the first through hole 21 located toward the second portion 35 in the second direction D2 is referred to as the inner side, and the side opposite to the inner side is referred to as the outer side of the first through hole 21 in the second direction D2. The outer side of the first through hole 21 in the second direction D2 is free from a rib that opposes the second portion 35 in the second direction D2. With this structure, the outer side of the first through hole 21 in the second direction D2 is free from a rib that opposes the second portion 35 in the second direction D2. Thus, the water collected around the first through hole 21 is easily drained out of the first end 14 in the second direction D2. This avoids corrosion of the fastened bolt in the first through hole 21.

(4) Multiple terminals 12 are arranged next to each other in the second direction D2. This structure allows the terminal block 10 of the terminals 12 to be reduced in length in the third direction D3.

(5) The first end 14 includes the bottom wall 14a having the upper surface. The bottom wall 14a includes the drain portion 36 shaped such that the upper surface becomes closer to the lower surface from the side of the second end 15 toward the side of the first end 14. With this structure, the drain portion 36 allows the water collected on the upper surface of the first end 14 to be drained toward the edge of the first end 14 in the second direction D2.

(6) The upper surface of the drain portion 36 is stepped such that the upper surface becomes closer to the lower surface from the side of the second end 15 toward the side of the first end 14. This structure allows the block main body 11 to be easily removed from a mold, thereby improving moldability of the block main body 11.

(7) The lower surface of the bottom wall 14a includes the recess 38 that receives the sealing member 37. The recess 38 is arranged in the lower surface of the bottom wall 14a so as not to extend across the steps of the drain portion 36. With this structure, the lower surface of the bottom wall 14a, including the recess 38, can be shaped in correspondence with the steps of the upper surface of the drain portion 36. Accordingly, the bottom wall 14a has minimal changes in the thickness. This avoids deformation, such as shrinkage, that would be caused by unevenness in the thickness of the bottom wall 14a.

(8) Two first through holes 21 are arranged next to each other in a direction that is orthogonal to the first direction D1 and intersects the second direction D2. The block main body 11 includes the rib 32 arranged between the two first through holes 21 and extending in the first direction D1. The rib 32 extends in the second direction D2 as viewed in the first direction D1. This structure further improves the strength of the first end 14. Also, the rib 32 functions as a guide for draining the water collected on the upper surface of the first end 14 toward the edge of the first end 14 in the second direction D2.

(9) In the block main body 11, the number of ribs in the first rib group 31 arranged on the first end 14, which is located at the lower side with respect to the inclination, is greater than the number of ribs in the second rib group 41 arranged on the second end 15, which is located at the upper side with respect to the inclination. With this structure, the first rib group 31 having a greater number of ribs improves the strength of the first end 14, which is where load is applied, in particular, because of the tilt of the block main body 11. This avoids deformation of the first end 14.

The present embodiment may be modified as follows. The present embodiment and the following modifications can be combined as long as the combined modifications remain technically consistent with each other.

In the lower surface of the bottom wall 14a, the recess 38 may be arranged to extend across the steps of the drain portion 36. Alternatively, the lower surface of the bottom wall 14a does not have to include the recess 38. In this case, the lower surface of the drain portion 36 may be entirely flat and perpendicular to the first direction D1.

The upper surface of the drain portion 36 may only be shaped such that the upper surface becomes closer to the lower surface from the side of the second end 15 toward the side of the first end 14. In the above embodiment, the upper surface of the drain portion 36 is stepped such that the upper surface becomes closer to the lower surface from the side of the second end 15 toward the side of the first end 14. However, instead of the steps, the upper surface of the drain portion 36 may be a sloped surface inclined toward the lower surface from the side of the second end 15 located toward the side of the first end 14.

The drain portion 36 may be omitted from the bottom wall 14a, and the upper surface of the bottom wall 14a may be evenly flat and perpendicular to the first direction D1.

The terminals 12 do not have to be arranged as described in the above embodiment. For example, the terminals 12 may be arranged next to each other in the third direction D3.

The number of ribs in the first rib group 31 arranged on the first end 14 and the number of ribs in the second rib group 41 arranged on the second end 15 are not limited to those in the above embodiment. For example, in the above embodiment, the first rib group 31 has a greater number of ribs than the second rib group 41. However, the second rib group 41 may have a greater number of ribs than the first rib group 31.

The number of first through holes 21 arranged in the first end 14 and the number of second through holes 22 arranged in the second end 15 are not limited to those in the above embodiment. The numbers may be changed in accordance with the structure of the block main body 11. For example, the number of first through holes 21 arranged in the first end 14 may be one or three or greater. The first through holes 21 do not have to be arranged next to each other in the third direction D3. Further, the second through holes 22 do not have to be arranged next to each other in the third direction D3.

In the block main body 11 of the above embodiment, the second direction D2 that defines the first end 14 and the second end 15 coincides with the longitudinal direction of the block main body 11. However, there is no limit to such a structure. For example, the second direction D2 defining the first end 14 and the second end 15 may coincide with the latitudinal direction of the block main body 11.

In the above embodiment, the block main body 11 is longer in the second direction D2 than the third direction D3 as viewed in the first direction D1. However, there is no limit to such a structure. For example, the block main body 11 may be longer in the third direction D3 than the second direction D2. Alternatively, the block main body 11 may be substantially the same in length in the second direction D2 and the third direction D3.

The inclination angle of the block main body 11 in a state fastened to the coupling surface A is not limited to that described in the above embodiment. The inclination angle may be changed in accordance with the structure of the associated device and the like.

As shown in FIGS. 1 to 4 and 6, the outermost surface of each first fastening portion 16 may be part of the outermost surface of the block main body 11. The upper surface 16a of each first fastening portion 16 may be continuous with the outermost surface of the block main body 11 without, for example, a step. For example, between the upper surface 16a of the first fastening portion 16 and the outermost surface of the block main body 11, the block main body 11 does not have to include a recess, such as a groove, and/or a projection, such as a wall. The upper surface 16a of the first fastening portion 16 may be continuous with the outermost surface of the corresponding collar 23 without, for example, a step. For example, between the upper surface 16a of the first fastening portion 16 and the outermost surface of the collar 23, the block main body 11 does not have to include a recess, such as a groove, and/or a projection, such as a wall. The block main body 11 does not have a recess or a projection that would interfere with flow of water on the upper surface 16a of the first fastening portion 16 (between outermost surface of collar 23 and the outermost surface of block main body 11). This block main body 11 is advantageous in that the water collected on the upper surface 16a of the first fastening portion 16 readily flows out toward the outermost surface of the block main body 11 due to the gravitational force and/or the surface tension. For example, even when the block main body 11 is level, the water on the upper surface 16a of the first fastening portion 16 may flow out toward the outermost surface of the block main body 11 due to the surface tension.

As shown in FIGS. 2, 3, and 5, the outermost surface of each second fastening portion 17 may be part of the outermost surface of the block main body 11. The upper surface 17a of each second fastening portion 17 may be continuous with the outermost surface of the block main body 11 without, for example, a step. Further, the upper surface 17a of the second fastening portion 17 may be continuous with the outermost surface of the corresponding collar 23 without, for example, a step. For example, between the upper surface 17a of the second fastening portion 17 and the outermost surface of the collar 23, the block main body 11 does not have to include a recess, such as a groove, and/or a projection, such as a wall. The block main body 11 does not have a recess or a projection that would interfere with flow of water on the upper surface 17a of the second fastening portion 17 (between outermost surface of collar 23 and the outermost surface of block main body 11). This block main body 11 is advantageous in that the water collected on the upper surface 17a of the second fastening portion 17 readily flows out toward the outermost surface of the block main body 11 due to, for example, the gravitational force. For example, even when the block main body 11 is level, the water on the upper surface 17a of the second fastening portion 17 may flow out toward the outermost surface of the block main body 11 due to the surface tension.

The block main body 11 may be referred to as a synthetic resin platform or an insulating resin platform. The ribs of the block main body 11 may each be referred to as a reinforcement rib. The reinforcement rib is arranged on the outer surface of the block main body 11 and is formed from synthetic resin. The reinforcement rib limits bending and deformation of the block main body 11 and/or the terminal block 10. A conventional example of a terminal block includes a non-resin reinforcement member. The non-resin reinforcement member may be a metal reinforcement plate that is at least partially embedded in the resin part of the block main body and extending radially outward from the block main body. The terminal block 10 of the above embodiment does not include such a reinforcement member, or a metal reinforcement plate. The ribs of the block main body 11 eliminate the need for such a non-resin reinforcement member, or a metal reinforcement plate at least partially embedded in the resin part of the block main body.

The present examples and embodiments are to be considered as illustrative and not restrictive. The scope of the present invention is defined not by the above detailed description, but by the claims and their equivalents, and all variations within the scope of the claims and their equivalents are to be construed as being included in the disclosure.

### DESCRIPTION OF THE REFERENCE CHARACTERS

10 terminal block
11 block main body
12 terminal
12a one end
13 circumferential wall
14 first end
14a bottom wall
15 second end
15a bottom wall
16 first fastening portion
16a upper surface
16b lower surface
17 second fastening portion
17a upper surface
17b lower surface
18 main part
21 first through hole
22 second through hole
23 collar
31 first rib group
32 rib (third rib)
33 rib (first rib)
33a side surface
34 first portion
35 second portion
36 drain portion
36a boundary
37 sealing member
38 recess
38a edge
41 second rib group
42 rib
43 rib (second rib)
43a side surface
44 first portion
45 second portion
46 receding surface
A coupling surface
C1 center axis
C2 center axis
D1 first direction
D2 second direction
D3 third direction
G gravitational direction
L1 centerline
L2 reference line
S reference surface

1. A terminal block, comprising:
a block main body; and
terminals held by the block main body, wherein:
the block main body includes
a through hole for accommodating a fastened bolt,
a first end that is one end in a second direction that is orthogonal to a first direction in which the through hole extends through the block main body, and
a second end that is an end located opposite to the first end in the second direction;
the terminal block is used in a state in which the block main body is tilted and the first end is lower than the second end;
the through hole includes a first through hole extending through the first end in the first direction, and a second through hole extending through the second end in the first direction;
the block main body includes
a first rib extending in the first direction and shaped such that the first rib extends around a side of the first through hole that is located toward the second end as viewed in the first direction, and
a second rib extending in the first direction and shaped such that the second rib extends around a side of the second through hole that is located toward the first end as viewed in the first direction;
a straight line orthogonal to a center axis of the second through hole and parallel to the second direction is referred to as a reference line; and
the second rib includes a side surface located toward the second through hole, the side surface including a receding surface that extends away from the second through hole as the receding surface becomes farther away from the reference line.

2. The terminal block according to claim 1, wherein:
the first rib includes a side surface located toward the first through hole, the side surface being entirely arc-shaped and centered about a center axis of the first through hole.

3. The terminal block according to claim 1, wherein:
in the block base body, a side of the first through hole located toward the first rib in the second direction is referred to as an inner side, and a side of the first through hole opposite to the inner side in the second direction is referred to as an outer side; and
the outer side of the first through hole in the second direction is free from a rib that opposes the first rib in the second direction.

4. The terminal block according to claim 1, wherein:
the terminals are arranged next to each other in the second direction.

5. The terminal block according to claim 1, wherein:
the first end includes a bottom wall having an upper surface; and
the bottom wall includes a drain portion shaped such that the upper surface becomes closer to a lower surface from a side of the second end toward a side of the first end.

6. The terminal block according to claim 5, wherein:
the upper surface of the drain portion is stepped such that the upper surface becomes closer to the lower surface from the side of the second end toward the side of the first end.

7. The terminal block according to claim 6, wherein:
the lower surface of the bottom wall includes a recess that receives a sealing member; and
the recess is arranged in the lower surface of the bottom wall so as not to extend across steps of the drain portion.

8. The terminal block according to claim 1, wherein:
the first through hole includes two first through holes arranged next to each other in a direction that is orthogonal to the first direction and intersects the second direction;
the block main body includes a third rib arranged between the two first through holes and extending in the first direction; and
the third rib extends in the second direction as viewed in the first direction.
